(19) United States
(12) Patent Application Publication
(10) Pub. No.: US 2020/0239072 A1
(43) Pub. Date: Jul. 30, 2020

(54) VEHICLE CONTROL DEVICE, VEHICLE, AND VEHICLE CONTROL METHOD

(71) Applicant: HONDA MOTOR CO., LTD., Tokyo (JP)

(72) Inventors: Nozomu HIROSAWA, Wako-Shi (JP); Tadahiko KANOH, Wako-Shi (JP); Kanta TSUJI, Wako-Shi (JP); Daichi KATO, Wako-Shi (JP); Atsushi ISHIOKA, Wako-Shi (JP); Katsuya YASHIRO, Wako-Shi (JP); Yuta TAKADA, Tokyo (JP)

(21) Appl. No.: 16/773,222

(22) Filed: Jan. 27, 2020

(30) Foreign Application Priority Data
Jan. 28, 2019 (JP) 2019-011782

(51) Int. Cl. B62D 15/02; B62D 1/04

(52) U.S. Cl. CPC B62D 15/0255; B62D 1/04

(57) ABSTRACT

A vehicle control device includes a lane change control unit that controls a lane change on the basis of an operation input to operation input units provided on a steering unit. In the case that the operation input to a first operation input unit, which is positioned on one side in a vehicle widthwise direction with respect to a center of a steering wheel, is detected, the lane change control unit performs a lane change into a lane located on one side of a host vehicle lane, whereas in the case that the operation input to a second operation input unit, which is positioned on another side in the vehicle widthwise direction with respect to the center of the steering wheel, is detected, the lane change control unit performs a lane change into a lane located on another side of the host vehicle lane.

### CROSS-REFERENCE TO RELATED APPLICATION

This application is based upon and claims the benefit of priority from Japanese Patent Application No. 2019-011782 filed on Jan. 28, 2019, the contents of which are incorporated herein by reference.

### BACKGROUND OF THE INVENTION

### Field of the Invention

The present invention relates to a vehicle control device, a vehicle, and a vehicle control method.

### Description of the Related Art

Recently, vehicle control devices have been proposed which are capable of controlling a lane change. In Japanese Laid-Open Patent Publication No. 2017-102519, it is disclosed to detect that a driver has permitted the vehicle to make a lane change, on the basis of an operation input made by the driver to a predetermined operating member.

### SUMMARY OF THE INVENTION

However, the proposed vehicle control device is not capable of always realizing sufficiently suitable operability.

An object of the present invention is to provide a vehicle control device, a vehicle, and a vehicle control method having suitable operability.

A vehicle control device according to one aspect of the present invention comprises an operation detection unit configured to detect an operation input performed by a user to an operation input unit provided on a steering unit including a steering wheel, and a lane change control unit configured to control a lane change on a basis of the operation input detected by the operation detection unit, wherein the operation input unit includes a first operation input unit positioned on one side in a vehicle widthwise direction with respect to a center of the steering wheel, and a second operation input unit positioned on another side in the vehicle widthwise direction with respect to the center of the steering wheel, and in a case that the operation input to the first operation input unit is detected by the operation detection unit, the lane change control unit performs the lane change into a first lane located on one side of a host vehicle lane which is a lane in which a host vehicle is traveling, whereas in a case that the operation input to the second operation input unit is detected by the operation detection unit, the lane change control unit performs the lane change into a second lane located on another side of the host vehicle lane.

A vehicle according to another aspect of the present invention comprises the vehicle control device as described above.

A vehicle control method according to still another aspect of the present invention comprises a step of detecting an operation input performed by a user to an operation input unit provided on a steering unit including a steering wheel, and a step of controlling a lane change on a basis of the operation input detected in the step of detecting the operation input, wherein the operation input unit includes a first operation input unit positioned on one side in a vehicle widthwise direction with respect to a center of the steering wheel, and a second operation input unit positioned on another side in the vehicle widthwise direction with respect to the center of the steering wheel, and in the step of controlling the lane change, in a case that the operation input to the first operation input unit is detected, the lane change is performed into a first lane located on one side of a host vehicle lane which is a lane in which a host vehicle is traveling, whereas in a case that the operation input to the second operation input unit is detected, the lane change is performed into a second lane located on another side of the host vehicle lane.

According to the present invention, it is possible to provide a vehicle control device, a vehicle, and a vehicle control method having suitable operability.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a block diagram showing a vehicle according to a first embodiment;

FIG. 2 is a diagram illustrating an example of an operation input unit provided in the vehicle according to the first embodiment;

FIG. 3 is a view showing an example of a travel lane;

FIG. 4 is a flowchart showing an example of operations of the vehicle control device according to the first embodiment;

FIG. 5 is a flowchart illustrating an example of operations of the vehicle control device according to a modification of the first embodiment;

FIG. 6 is a diagram illustrating an example of an operation input unit provided in a vehicle according to the second embodiment;

FIG. 7 is a block diagram showing a vehicle according to a third embodiment;

FIG. 8 is a diagram illustrating an example of an operation input unit provided in the vehicle according to the third embodiment; and

FIG. 9 is a flowchart showing an example of operations of the vehicle control device according to the third embodiment.

### DESCRIPTION OF THE PREFERRED EMBODIMENTS

Preferred embodiments of a vehicle control device, a vehicle, and a vehicle control method according to the present invention will be presented and described in detail below with reference to the accompanying drawings.

### First Embodiment

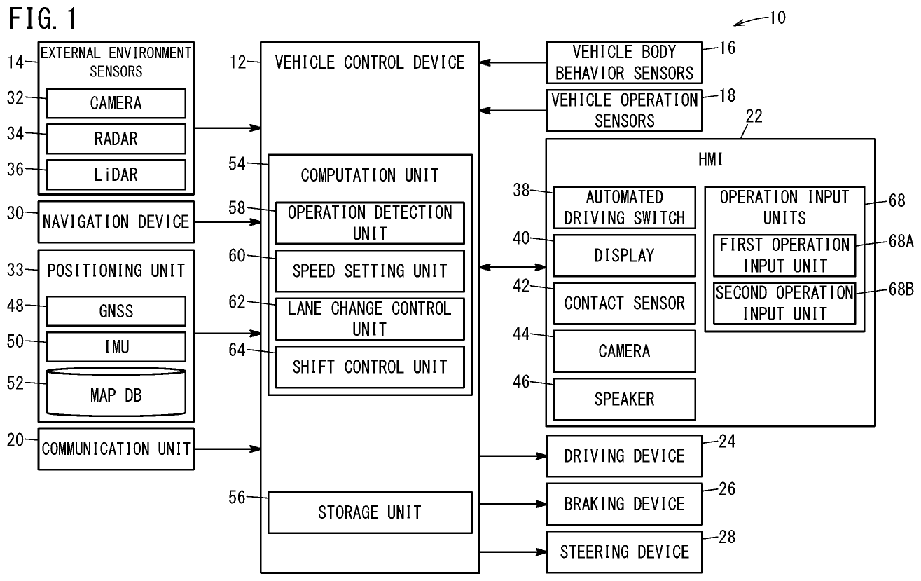

A vehicle control device, a vehicle, and a vehicle control method according to a first embodiment will be described with reference to the drawings. FIG. 1 is a block diagram showing a vehicle according to the present embodiment.

A vehicle (host vehicle, driver's own vehicle) 10 is equipped with a vehicle control device 12, namely, a vehicle control ECU (Electronic Control Unit). The vehicle 10 is further equipped with external environment sensors 14, vehicle body behavior sensors 16, vehicle operation sensors 18, a communication unit 20, and an HMI (Human Machine Interface) 22. The vehicle 10 is further equipped with a driving device 24, a braking device 26, a steering device 28, a navigation device 30, and a positioning unit 33. Although the vehicle 10 is equipped with other constituent elements apart from those noted above, description of such elements is omitted herein.

The external environment sensors 14 acquire external environmental information, that is, peripheral information around the vicinity of the vehicle 10. The external environment sensors 14 include a plurality of cameras 32 and a plurality of radar devices 34. Among the external environment sensors 14, there are further included a plurality of LiDAR (Light Detection And Ranging, Laser Imaging Detection and Ranging) devices 36.

Information acquired by cameras (imaging units) 32, i.e., camera information, is supplied from the cameras 32 to the vehicle control device 12. As such camera information, there may be cited captured image information and the like. The camera information, together with radar information and LiDAR information to be described later, makes up the external environmental information. Although a single camera 32 is illustrated in FIG. 1, a plurality of cameras 32 are actually provided.

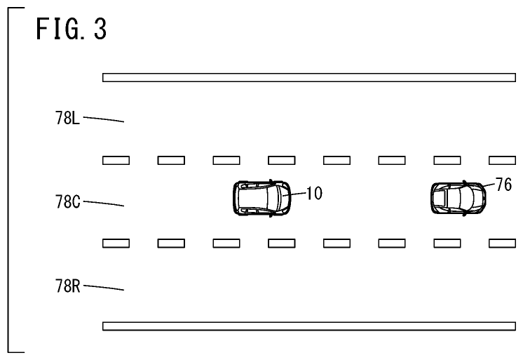

The radar devices 34 emit transmitted waves toward the exterior of the vehicle 10, and receive reflected waves that are reflected and returned by detected objects. As examples of the transmitted waves, there may be cited electromagnetic waves. As examples of the electromagnetic waves, there may be cited millimeter waves. As examples of the detected objects, there may be cited another vehicle 76 including a preceding vehicle (see FIG. 3). The radar devices 34 generate radar information (reflected wave signals) based on the reflected waves or the like. The radar devices 34 supply the generated radar information to the vehicle control device 12. Although one radar device 34 is illustrated in FIG. 1, a plurality of radar devices 34 are actually provided in the vehicle 10. Moreover, the radar devices 34 are not limited to using millimeter wave radar. For example, laser radar devices, or ultrasonic sensors or the like may be used as the radar devices 34.

The LiDAR devices 36 continuously irradiate lasers in all directions of the vehicle 10, measure the three-dimensional position of reflection points based on reflected waves of the emitted lasers, and output information, i.e., three dimensional information, in relation to the three-dimensional positions. The LiDAR devices 36 supply the three-dimensional information, i.e., LiDAR information, to the vehicle control device 12. Although one LiDAR device 36 is illustrated in FIG. 1, a plurality of LiDAR devices 36 are actually provided in the vehicle 10.

The vehicle body behavior sensors 16 acquire information, namely, vehicle body behavior information, in relation to the behavior of the vehicle 10. The vehicle body behavior sensors 16 include a non-illustrated vehicle speed sensor, non-illustrated vehicle wheel speed sensors, a non-illustrated acceleration sensor, and a non-illustrated yaw rate sensor. The vehicle speed sensor detects the speed, i.e., the vehicle speed, of the vehicle 10. Further, the vehicle speed sensor detects the direction in which the vehicle 10 is traveling. The vehicle wheel speed sensors detect the speed, i.e., the vehicle wheel speed, of the non-illustrated vehicle wheels. The acceleration sensor detects the acceleration of the vehicle 10. The term “acceleration” includes a longitudinal acceleration, a lateral acceleration, and a vertical acceleration. It should be noted that the acceleration of only a portion of the aforementioned directions may be detected by the acceleration sensor. The yaw rate sensor detects a yaw rate of the vehicle 10.

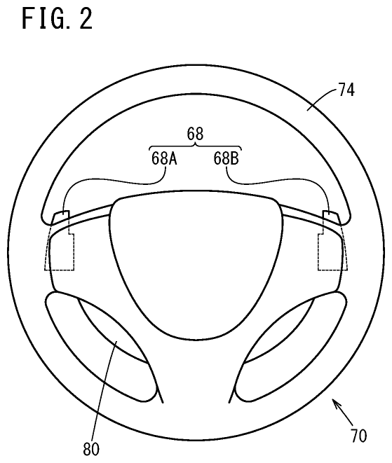

The vehicle operation sensors (driving operation sensors) 18 acquire information, namely, driving operation information, in relation to driving operations made by a user (driver). The vehicle operation sensors 18 include a non-illustrated accelerator pedal sensor, a non-illustrated brake pedal sensor, a non-illustrated steering angle sensor, and a non-illustrated steering torque sensor. The accelerator pedal sensor detects an operated amount of a non-illustrated accelerator pedal. The brake pedal sensor detects an operated amount of a non-illustrated brake pedal. The steering angle sensor detects the steering angle of a steering wheel 74 (see FIG. 2). The torque sensor detects a torque applied to the steering wheel 74.

The communication unit 20 performs wireless communications with non-illustrated external equipment. The external equipment may include, for example, a non-illustrated external server. The communication unit 20 may be capable of being detached from the vehicle 10, or may be non-detachable with respect to the vehicle. As examples of the communication unit 20 that can be attached to and detached from the vehicle 10, there may be cited a mobile phone and a smartphone.

The HMI 22 receives an operation input made by the user (vehicle occupant), and provides various types of information to the user in a visual, audible, or tactile manner. The HMI 22 includes, for example, an automated driving switch (driving assist switch) 38, a display 40, a contact sensor 42, a camera 44, a speaker 46, and operation input units 68.

The automated driving switch 38 is used by the user in order to instruct starting or stopping of automated driving. The automated driving switch 38 includes a non-illustrated start switch and a non-illustrated stop switch. The start switch outputs a start signal to the vehicle control device 12 in accordance with an operation of the user. The stop switch outputs a stop signal to the vehicle control device 12 in accordance with an operation of the user.

The display (display unit) 40 includes, for example, a liquid crystal panel or an organic EL panel or the like. In this instance, although an exemplary case will be described in which the display 40 is a touch panel, the present invention is not limited to this feature.

The contact sensor 42 serves to detect whether or not the user (driver) is touching the steering wheel 74. Signals output from the contact sensor 42 are supplied to the vehicle control device 12. On the basis of input signals supplied from the contact sensor 42, the vehicle control device 12 is capable of determining whether or not the user is touching the steering wheel 74.

The camera 44 captures images of the interior, i.e., a non-illustrated vehicle compartment interior, of the vehicle 10. The camera 44 may be disposed, for example, on a non-illustrated dashboard, or may be disposed on a non-illustrated ceiling of the vehicle 10. Further, the camera 44 may be disposed in a manner so that images are captured of only the driver, or may be disposed in a manner so that images are captured of each of the vehicle occupants. The camera 44 outputs information, i.e., image information, which is acquired by capturing images of the vehicle compartment interior, to the vehicle control device 12.

The speaker 46 serves to provide various types of information to the user by way of sound or voice. The vehicle control device 12 outputs various notifications, alarms, or the like using the speaker 46.

FIG. 2 is a diagram illustrating an example of an operation input unit provided in the vehicle according to the present embodiment.

As shown in FIG. 2, in a steering unit 70, there are provided the steering wheel 74 and the operation input units 68. The operation input units 68 may be provided on the steering wheel 74, or may be provided on a steering column 80. In FIG. 2, an example is shown in which the operation input units 68 are provided on the steering wheel 74.

The operation input units 68 include a first operation input unit 68A and a second operation input unit 68B. The first operation input unit 68A is a first operation switch provided on a rear side (rear surface side) of the steering wheel 74. The first operation switch, for example, is a lever-shaped switch. The second operation input unit 68B is a second operation switch provided on the rear side (rear surface side) of the steering wheel 74. The second operation switch, for example, is a lever-shaped switch. The first operation input unit 68A is positioned on one side, namely on the left side, in a vehicle widthwise direction with respect to the center of the steering wheel 74. The second operation input unit 68B is positioned on another side, namely on the right side, in the vehicle widthwise direction with respect to the center of the steering wheel 74. Moreover, in this instance, an exemplary case is described in which the first operation switch that makes up the first operation input unit 68A and the second operation switch that makes up the second operation input unit 68B are lever-shaped switches. However, the present invention is not limited to this feature. The first operation switch and the second operation switch may be configured, for example, by push button switches.

The operation input units 68 can be used when performing a speed change or gear shifting operation. The first operation input unit 68A is a switch, i.e., a downshift switch, for performing a downshifting operation. The second operation input unit 68B is a switch, i.e., an upshift switch, for performing an upshifting operation. Operation input units 68 of this type are referred to as paddle shift switches. The first operation input unit 68A supplies, to a later-described operation detection unit 58, a signal indicating an operation state of the first operation input unit 68A. Further, the second operation input unit 68B supplies, to the operation detection unit 58, a signal indicating an operation state of the second operation input unit 68B.

The operation input units 68 can be used when performing a lane change. The first operation input unit 68A can be used when a lane change is made into a lane 78L located on a left side of a host vehicle lane 78C (see FIG. 3). The second operation input unit 68B can be used when a lane change is made into a lane 78R located on a right side of the host vehicle lane 78C (see FIG. 3).

The driving device (driving force control system) 24 includes a non-illustrated drive ECU, and a non-illustrated drive source. By controlling the drive source, the drive ECU controls the driving force (torque) of the vehicle 10. As examples of the drive source, there may be cited an engine or a drive motor. The drive ECU is capable of controlling the driving force by controlling the drive source, based on an operation made by the user on the accelerator pedal. Further, the drive ECU is capable of controlling the driving force by controlling the drive source, based on a command supplied from the vehicle control device 12. The driving force of the drive source is transmitted to the non-illustrated vehicle wheels via a non-illustrated transmission.

The braking device (braking force control system) 26 includes a non-illustrated brake ECU, and a non-illustrated brake mechanism. The brake mechanism actuates a brake member by a brake motor, a hydraulic mechanism, or the like. The brake ECU is capable of controlling the braking force by controlling the drive mechanism, based on an operation made by the user on the brake pedal. Further, the brake ECU is capable of controlling the braking force by controlling the brake mechanism, based on a command supplied from the vehicle control device 12.

The steering device (steering system) 28 includes a non-illustrated steering ECU, and more specifically, an EPS (electric power steering system) ECU, and a non-illustrated steering motor. The steering ECU controls the direction of the vehicle wheels (steering wheels) by controlling the steering motor, based on an operation made by the user on the steering wheel 74. Further, the steering ECU controls the direction of the vehicle wheels by controlling the steering motor, based on a command supplied from the vehicle control device 12. Steering may be performed by changing the torque distribution and the braking force distribution to the left and right vehicle wheels.

The navigation device 30 is equipped with a non-illustrated GNSS (Global Navigation Satellite System) sensor. In addition, the navigation device 30 is further equipped with a non-illustrated computation unit and a non-illustrated storage unit. The GNSS sensor detects the current position of the vehicle 10. From a map database stored in the storage unit, the computation unit reads out map information corresponding to the current position detected by the GNSS sensor. Using the map information, the computation unit determines a target route from the current position to a destination. The destination is input by the user via the HMI 22. As described above, the display 40 is a touch panel. The destination is input by the touch panel being operated by the user. The navigation device 30 outputs the created target route to the vehicle control device 12. The vehicle control device 12 supplies the target route to the HMI 22. The HMI 22 displays the target route on the display 40.

The positioning unit 33 is equipped with a GNSS 48. The positioning unit 33 is further provided with an IMU (Inertial Measurement Unit) 50 and a map database (map DB) 52. The positioning unit 33 specifies the position of the vehicle 10 by appropriately using the information obtained by the GNSS 48, the information obtained by the IMU 50, and the map information stored in the map database 52. The positioning unit 33 is capable of supplying host vehicle position information, which is information indicative of the position of the host vehicle 10, to the vehicle control device 12. Further, the positioning unit 33 is capable of supplying the map information to the vehicle control device 12.

The vehicle control device 12 is equipped with a computation unit 54 and a storage unit 56. The computation unit 54 governs the overall control of the vehicle control device 12. The computation unit 54 is constituted, for example, by a CPU (Central Processing Unit). The computation unit 54 executes the vehicle control by controlling each of the respective units based on programs stored in the storage unit 56.

The computation unit 54 is equipped with the operation detection unit 58, a speed setting unit 60, a lane change control unit 62, and a shift control unit 64. The operation detection unit 58, the speed setting unit 60, the lane change control unit 62, and the shift control unit 64 can be realized by the computation unit 54 executing programs which are stored in the storage unit 56.

The operation detection unit 58 detects operation inputs performed by the user to the operation input units 68. On the basis of signals supplied from the first operation input unit 68A, the operation detection unit 58 detects operation inputs performed by the user to the first operation input unit 68A. On the basis of signals supplied from the second operation input unit 68B, the operation detection unit 58 detects operation inputs performed by the user to the second operation input unit 68B. As described above, the signals supplied from the first operation input unit 68A are signals indicative of the operation state of the first operation input unit 68A. As described above, the signals supplied from the second operation input unit 68B are signals indicative of the operation state of the second operation input unit 68B.

FIG. 3 is a view showing an example of a travel lane. FIG. 3 shows an example of a case in which the host vehicle 10 and another vehicle 76 are traveling in the host vehicle lane 78C. A first lane (lane, adjacent lane) 78L is located on one side (a left side) of the host vehicle lane (lane) 78C, which is a lane in which the host vehicle 10 is traveling. A second lane (lane, adjacent lane) 78R is located on another side (a right side) of the host vehicle lane (lane) 78C, which is the lane in which the host vehicle 10 is traveling. Moreover, in FIG. 3, an example is illustrated in which only one other vehicle 76, namely, a preceding vehicle, exists in front of the host vehicle 10, however, the present invention is not limited to this feature. There may also be cases in which a plurality of other vehicles 76 are present. Further, there may also be cases in which another vehicle 76 exists in the first lane 78L, or in which another vehicle 76 exists in the second lane 78R. It should be noted that, when describing the lanes in general, the reference numeral 78 is used, and when describing individual lanes, the reference numerals 78C, 78L, and 78R are used.

The lane change control unit (control unit) 62 is capable of controlling a lane change on the basis of an operation input detected by the operation detection unit 58. More specifically, in the case that an operation input to the first operation input unit 68A is detected by the operation detection unit 58, the lane change control unit 62 is capable of performing a lane change into the lane 78L located on the left side of the host vehicle lane 78C. Further, in the case that an operation input to the second operation input unit 68B is detected by the operation detection unit 58, the lane change control unit 62 is capable of performing a lane change into the lane 78R located on the right side of the host vehicle lane 78C.

The shift control unit 64 is capable of performing a shift control on the basis of an operation input detected by the operation detection unit 58. More specifically, in the case that an operation input to the first operation input unit 68A is detected by the operation detection unit 58, the shift control unit 64 can perform a downshift control. Further, in the case that an operation input to the second operation input unit 68B is detected by the operation detection unit 58, the shift control unit 64 can perform an upshift control.

The storage unit 56 includes a non-illustrated volatile memory, and a non-illustrated nonvolatile memory. As an example of the volatile memory, there may be cited a RAM (Random Access Memory). As an example of the nonvolatile memory, there may be cited a ROM (Read Only Memory), a flash memory, or the like. The external environmental information, the vehicle body behavior information, and the vehicle operation information, etc., are stored, for example, in the volatile memory. Programs, tables, maps, and the like are stored, for example, in the nonvolatile memory.

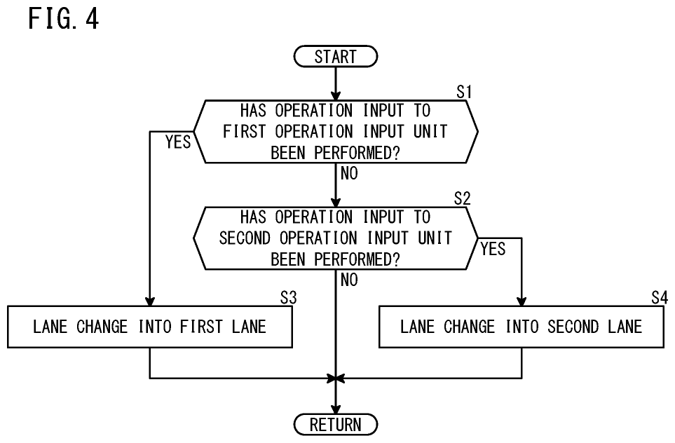

FIG. 4 is a flowchart showing an example of operations of the vehicle control device according to the present embodiment.

In step S1, on the basis of a signal supplied from the first operation input unit 68A, the operation detection unit 58 detects whether or not an operation input to the first operation input unit 68A has been performed by the user. If such an operation input to the first operation input unit 68A is performed (YES in step S1), the process transitions to step S3. If such an operation input to the first operation input unit 68A is not performed (NO in step S1), the process transitions to step S2.

In step S2, on the basis of a signal supplied from the second operation input unit 68B, the operation detection unit 58 detects whether or not an operation input to the second operation input unit 68B has been performed by the user. If such an operation input to the second operation input unit 68B is performed (YES in step S2), the process transitions to step S4. If such an operation input to the second operation input unit 68B is not performed (NO in step S2), the process shown in FIG. 4 is brought to an end.

In step S3, the lane change control unit 62 makes a lane change into the lane 78L located on the left side of the host vehicle lane 78C. Upon completion of step S3, the process shown in FIG. 4 is brought to an end.

In step S4, the lane change control unit 62 makes a lane change into the lane 78R located on the right side of the host vehicle lane 78C. Upon completion of step S4, the process shown in FIG. 4 is brought to an end.

In the foregoing manner, according to the present embodiment, in the case that an operation input to the first operation input unit 68A, which is positioned on the one side in the vehicle widthwise direction with respect to the center of the steering wheel 74, is performed, a lane change is made into the lane 78L located on the one side of the host vehicle lane 78C. Further, in the case that an operation input to the second operation input unit 68B, which is positioned on the other side in the vehicle widthwise direction with respect to the center of the steering wheel 74, is performed, a lane change is made into the lane 78R located on the other side of the host vehicle lane 78C. Therefore, according to the present embodiment, it is possible for the vehicle control device 12 having suitable operability to be provided.

### (Modification 1)

A vehicle control device, a vehicle, and a vehicle control method according to a first modification of the present embodiment will be described with reference to the drawings.

The vehicle control device 12 according to the present modification comprises a first mode and a second mode. The first mode is a mode in which the operation input to the operation input units 68 is detected as a request to perform a lane change made by the user. The second mode is a mode in which the operation input to the operation input units 68 is detected as a consent from the user to a proposal to perform the lane change.

According to the present modification, the operation detection unit 58 detects the operation input on the basis of an amount of operation, which is performed by the user to the operation input units 68, having reached an operation amount threshold value. The operation amount threshold value (second operation amount threshold value) in the second mode is set to be less than the operation amount threshold value (first operation amount threshold value) in the first mode. The operation amount threshold value in the first mode can be set to about 1 second, for example, but is not limited thereto. The operation amount threshold value in the second mode can be set to about 0.1 second, for example, but is not limited thereto.

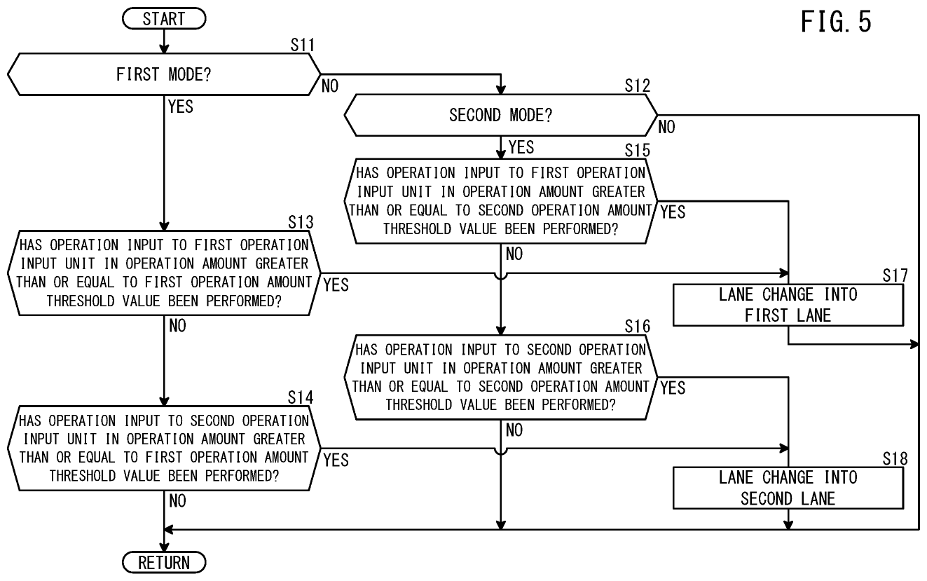

FIG. 5 is a flowchart illustrating an example of operations of the vehicle control device according to the present modification.

First, in step S11, the computation unit 54 determines whether or not the current operation mode is the first mode. As noted previously, the first mode is a mode in which the operation input to the operation input units 68 is detected as a request to perform a lane change made by the user. If the current operation mode is the first mode (YES in step S11), the process transitions to step S13. If the current operation mode is not the first mode (NO in step S11), the process transitions to step S12.

In step S12, the computation unit 54 determines whether or not the current operation mode is the second mode. As noted previously, the second mode is a mode in which the operation input to the operation input units 68 is detected as a consent from the user to a proposal to perform the lane change. If the current operation mode is the second mode (YES in step S12), the process transitions to step S15. If the current operation mode is not the second mode (NO in step S12), the process shown in FIG. 5 is brought to an end.

In step S13, the operation detection unit 58 detects, on the basis of a signal supplied from the first operation input unit 68A, whether or not an operation input to the first operation input unit 68A in an operation amount greater than or equal to the first operation amount threshold value has been performed. If an operation input to the first operation input unit 68A in an operation amount greater than or equal to the first operation amount threshold value has been performed (YES in step S13), the process transitions to step S17. If an operation input to the first operation input unit 68A in an operation amount greater than or equal to the first operation amount threshold value has not been performed (NO in step S13), the process transitions to step S14.

In step S14, the operation detection unit 58 detects, on the basis of a signal supplied from the second operation input unit 68B, whether or not an operation input to the second operation input unit 68B in an operation amount greater than or equal to the first operation amount threshold value has been performed. If an operation input to the second operation input unit 68B in an operation amount greater than or equal to the first operation amount threshold value has been performed (YES in step S14), the process transitions to step S18. If an operation input to the second operation input unit 68B in an operation amount greater than or equal to the first operation amount threshold value has not been performed (NO in step S14), the process shown in FIG. 5 is brought to an end.

In step S15, the operation detection unit 58 detects, on the basis of a signal supplied from the first operation input unit 68A, whether or not an operation input to the first operation input unit 68A in an operation amount greater than or equal to the second operation amount threshold value has been performed. If an operation input to the first operation input unit 68A in an operation amount greater than or equal to the second operation amount threshold value has been performed (YES in step S15), the process transitions to step S17. If an operation input to the first operation input unit 68A in an operation amount greater than or equal to the second operation amount threshold value has not been performed (NO in step S15), the process transitions to step S16.

In step S16, the operation detection unit 58 detects, on the basis of a signal supplied from the second operation input unit 68B, whether or not an operation input to the second operation input unit 68B in an operation amount greater than or equal to the second operation amount threshold value has been performed. If an operation input to the second operation input unit 68B in an operation amount greater than or equal to the second operation amount threshold value has been performed (YES in step S16), the process transitions to step S18. If an operation input to the second operation input unit 68B in an operation amount greater than or equal to the second operation amount threshold value has not been performed (NO in step S16), the process shown in FIG. 5 is brought to an end.

In step S17, the lane change control unit 62 makes a lane change into the lane 78L located on the left side of the host vehicle lane 78C. Upon completion of step S17, the process shown in FIG. 5 is brought to an end.

In step S18, the lane change control unit 62 makes a lane change into the lane 78R located on the right side of the host vehicle lane 78C. Upon completion of step S18, the process shown in FIG. 5 is brought to an end.

In the foregoing manner, there may be provided the first mode in which the operation input to the operation input units 68 is detected as a request to perform a lane change, and the second mode in which the operation input to the operation input units 68 is detected as a consent from the user to a proposal to perform the lane change. In addition, the operation amount threshold value in the second mode may be set to be less than the operation amount threshold value in the first mode. According to the present modification, since the operation amount threshold value in the first mode is set to be comparatively large, it is possible to contribute to an improvement in safety when operating in the first mode. Further, according to the present modification, since the operation amount threshold value in the second mode is set to be comparatively small, it is possible to contribute to an improvement in operability when operating in the second mode.

### Second Embodiment

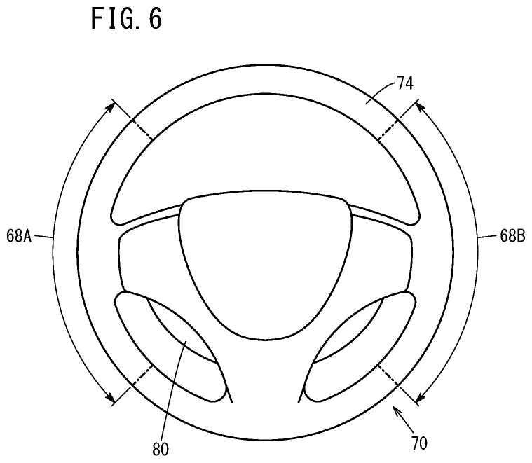

A vehicle control device, a vehicle, and a vehicle control method according to a second embodiment will be described with reference to the drawings. FIG. 6 is a diagram illustrating an operation input unit provided in the vehicle according to the present embodiment. The same components as those of the vehicle control device according to the first embodiment shown in FIGS. 1 to 5 are denoted by the same reference numerals, and description of such features is either omitted or simplified.

In the present embodiment, the steering wheel 74 is equipped with the first operation input unit 68A and the second operation input unit 68B. The first operation input unit 68A is a first contact sensor positioned on one side, namely on the left side, in the vehicle widthwise direction on the steering wheel 74, when the steering wheel 74 is in a neutral position. The second operation input unit 68B is a second contact sensor positioned on another side, namely on the right side, in the vehicle widthwise direction on the steering wheel 74, when the steering wheel 74 is in the neutral position.

The first operation input unit 68A and the second operation input unit 68B are capable of detecting, respectively, the contact location of the hands of the user with the steering wheel 74. The first operation input unit 68A, for example, includes a plurality of non-illustrated electrostatic capacitance sensors. When the steering wheel 74 is in the neutral position, the plurality of electrostatic capacitance sensors that make up the first operation input unit 68A are arranged along the circumferential direction of the steering wheel 74, so as to be positioned on the left side in the vehicle widthwise direction on the steering wheel 74. The second operation input unit 68B, for example, includes a plurality of non-illustrated electrostatic capacitance sensors. When the steering wheel 74 is in the neutral position, the plurality of electrostatic capacitance sensors that make up the second operation input unit 68B are arranged along the circumferential direction of the steering wheel 74, so as to be positioned on the right side in the vehicle widthwise direction on the steering wheel 74. At locations on the steering wheel 74 where the hands of the user have come into contact therewith, a change in capacitance is detected by the electrostatic capacitance sensors positioned at such locations. Therefore, the first operation input unit 68A and the second operation input unit 68B are capable of supplying to the operation detection unit 58 signals corresponding to the locations where the hands of the user have come into contact therewith.

Moreover, in this instance, although an exemplary case has been described in which the first operation input unit 68A is constituted by a plurality of capacitance sensors, and the second operation input unit 68B is constituted by a plurality of capacitance sensors, the present invention is not limited to this feature. The first operation input unit 68A may be constituted by a single capacitance sensor, and the second operation input unit 68B may be constituted by a single capacitance sensor. In this case, by further utilizing an image acquired by the camera 44, it is possible to detect the contact location of the hands of the user with the steering wheel 74.

Further, in the above description, although an exemplary case has been described in which the first operation input unit 68A and the second operation input unit 68B are provided with the capacitance sensors, the present invention is not limited to this feature. For example, pressure sensors or the like may be used instead of capacitance sensors. All types of sensors are capable of being used as appropriate.

According to the present embodiment, an operation input may be performed by causing the contact location of a hand of the user with the steering wheel 74 to move in a predetermined direction. The operation detection unit 58 is capable of detecting such an operation input on the basis of signals from the first operation input unit 68A and the second operation input unit 68B.

In the foregoing manner, the steering wheel 74 may be equipped with the first operation input unit 68A and the second operation input unit 68B. The first operation input unit 68A may be the first contact sensor which is positioned on the one side in the vehicle widthwise direction on the steering wheel 74, when the steering wheel 74 is in the neutral position. The second operation input unit 68B may be the second contact sensor which is positioned on the other side in the vehicle widthwise direction on the steering wheel 74, when the steering wheel 74 is in the neutral position. In addition, an operation input may be performed by causing the contact location with the steering wheel 74 to move in a predetermined direction.

### Third Embodiment

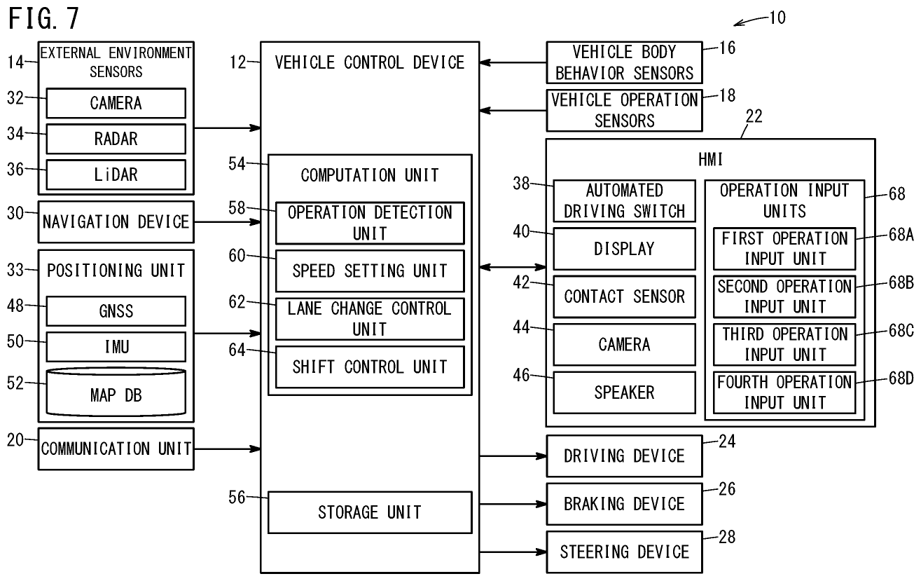

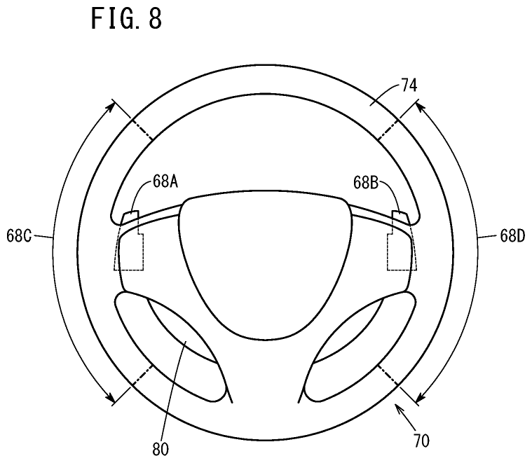

A vehicle control device, a vehicle, and a vehicle control method according to a third embodiment will be described with reference to the drawings. FIG. 7 is a block diagram showing a vehicle according to the present embodiment. FIG. 8 is a diagram illustrating an example of an operation input unit provided in the vehicle according to the present embodiment. The same components as those of the vehicle control device according to the first or the second embodiment shown in FIGS. 1 to 6 are denoted by the same reference numerals, and description of such features is either omitted or simplified.

As shown in FIGS. 7 and 8, the vehicle 10 according to the present embodiment includes the first operation input unit 68A, the second operation input unit 68B, as well as a third operation input unit 68C, and a fourth operation input unit 68D. The first operation input unit 68A in the present embodiment is provided on the rear side of the steering wheel 74, in the same manner as the first operation input unit 68A in the first embodiment. The second operation input unit 68B in the present embodiment is provided on the rear side of the steering wheel 74, in the same manner as the second operation input unit 68B in the first embodiment. The first operation input unit 68A is positioned on one side, namely on the left side, in a vehicle widthwise direction with respect to the center of the steering wheel 74. The second operation input unit 68B is positioned on another side, namely on the right side, in the vehicle widthwise direction with respect to the center of the steering wheel 74.

The third operation input unit 68C is the same as the first operation input unit 68A according to the second embodiment. The third operation input unit 68C is a first contact sensor positioned on one side, namely on the left side, in the vehicle widthwise direction with respect to the center of the steering wheel 74, when the steering wheel 74 is in the neutral position. The fourth operation input unit 68D is the same as the second operation input unit 68B according to the second embodiment. The fourth operation input unit 68D is a second contact sensor positioned on another side, namely on the right side, in the vehicle widthwise direction on the steering wheel 74, when the steering wheel 74 is in the neutral position.

The vehicle control device 12 according to the present embodiment includes a first driving control state in which the user is required to be grasping the steering wheel 74, and a second driving control state in which the user is not required to be grasping the steering wheel 74. In the first driving control state, the lane change control unit 62 performs a lane change on the basis of an operation input to the first operation input unit 68A or the second operation input unit 68B. In the second driving control state, the lane change control unit 62 performs a lane change on the basis of an operation input to the third operation input unit 68C or the fourth operation input unit 68D. Even in the second driving control state, which is a driving control state in which the user is not required to be grasping the steering wheel 74, the following process is performed in the case that the user is grasping the steering wheel 74. Specifically, in such a case, the lane change control is performed on the basis of the operation input to the first operation input unit 68A or the second operation input unit 68B. This is because, even in the second driving control state, which is a driving control state in which the user is not required to be grasping the steering wheel 74, there may be situations in which a user who feels a sense of insecurity may grasp the steering wheel 74.

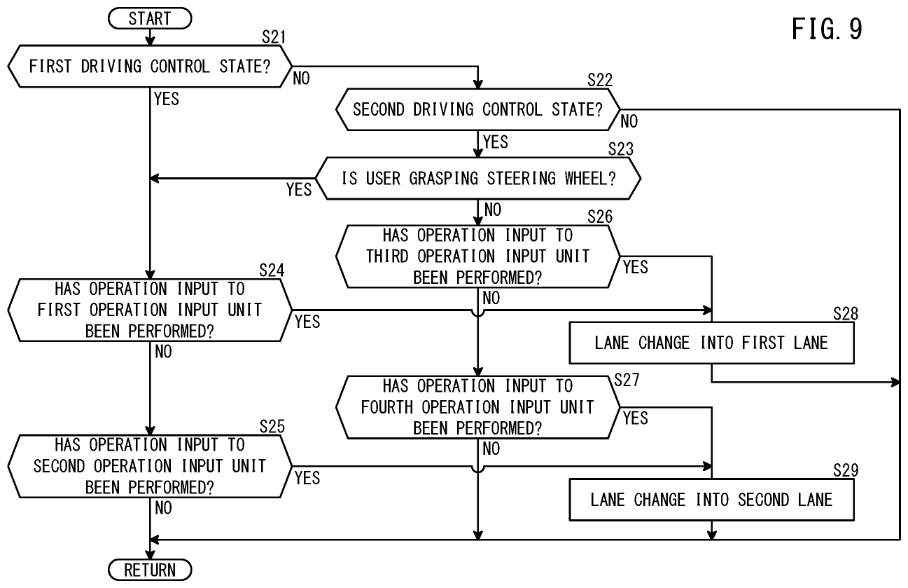

FIG. 9 is a flowchart showing an example of operations of the vehicle control device according to the present embodiment.

First, in step S21, the computation unit 54 determines whether or not the current driving control state is the first driving control state. As described above, the first driving control state is a driving control state in which the user is required to be grasping the steering wheel 74. If the current driving control state is the first driving control state (YES in step S21), the process transitions to step S24. If the current driving control state is not the first driving control state (NO in step S21), the process transitions to step S22.

In step S22, the computation unit 54 determines whether or not the current driving control state is the second driving control state. As described above, the second driving control state is a driving control state in which the user is not required to be grasping the steering wheel 74. If the current driving control state is the second driving control state (YES in step S22), the process transitions to step S23. If the current driving control state is not the second driving control state (NO in step S22), the process shown in FIG. 9 is brought to an end.

In step S23, the computation unit 54 determines whether or not the user is grasping the steering wheel 74. The computation unit 54 is capable of determining whether the user is grasping the steering wheel 74, for example, on the basis of a signal supplied from the contact sensor 42. In the case that the user is grasping the steering wheel 74 (YES in step S23), the process transitions to step S24. In the case that the user is not grasping the steering wheel 74 (NO in step S23), the process transitions to step S26.

In step S24, on the basis of a signal supplied from the first operation input unit 68A, the operation detection unit 58 detects whether or not an operation input to the first operation input unit 68A has been performed. If such an operation input to the first operation input unit 68A is performed (YES in step S24), the process transitions to step S28. If such an operation input to the first operation input unit 68A is not performed (NO in step S24), the process transitions to step S25.

In step S25, on the basis of a signal supplied from the second operation input unit 68B, the operation detection unit 58 detects whether or not an operation input to the second operation input unit 68B has been performed. If such an operation input to the second operation input unit 68B is performed (YES in step S25), the process transitions to step S29. If such an operation input to the second operation input unit 68B is not performed (NO in step S25), the process shown in FIG. 9 is brought to an end.

In step S26, on the basis of a signal supplied from the third operation input unit 68C, the operation detection unit 58 detects whether or not an operation input to the third operation input unit 68C has been performed. If such an operation input to the third operation input unit 68C is performed (YES in step S26), the process transitions to step S28. If such an operation input to the third operation input unit 68C is not performed (NO in step S26), the process transitions to step S27.

In step S27, on the basis of a signal supplied from the fourth operation input unit 68D, the operation detection unit 58 detects whether or not an operation input to the fourth operation input unit 68D has been performed. If such an operation input to the fourth operation input unit 68D is performed (YES in step S27), the process transitions to step S29. If such an operation input to the fourth operation input unit 68D is not performed (NO in step S27), the process shown in FIG. 9 is brought to an end.

In step S28, the lane change control unit 62 makes a lane change into the lane 78L located on the left side of the host vehicle lane 78C. Upon completion of step S28, the process shown in FIG. 9 is brought to an end.

In step S29, the lane change control unit 62 makes a lane change into the lane 78R located on the right side of the host vehicle lane 78C. Upon completion of step S29, the process shown in FIG. 9 is brought to an end.

In the manner described above, in the first driving control state, a lane change may be performed on the basis of the operation input to the first operation input unit 68A or the second operation input unit 68B. On the other hand, in the second driving control state, a lane change may be performed on the basis of the operation input to the third operation input unit 68C or the fourth operation input unit 68D. Further, even in the second driving control state, in the case that the user is grasping the steering wheel 74, the lane change control may be performed on the basis of the operation input to the first operation input unit 68A or the second operation input unit 68B.

Although preferred embodiments of the present invention have been described above, the present invention is not limited to the above-described embodiments, and various modifications can be made thereto without departing from the essence and gist of the present invention.

Summarizing the embodiments described above, the following features and advantages are realized.

The vehicle control device (12) comprises the operation detection unit (58) that detects the operation inputs performed by the user to the operation input units (68) provided on the steering unit (70) including the steering wheel (74), and the lane change control unit (62) that controls a lane change on the basis of the operation input detected by the operation detection unit, wherein the operation input unit includes the first operation input unit (68A) positioned on one side in a vehicle widthwise direction with respect to the center of the steering wheel, and the second operation input unit (68B) positioned on the other side in the vehicle widthwise direction with respect to the center of the steering wheel, and in the case that the operation input to the first operation input unit is detected by the operation detection unit, the lane change control unit performs the lane change into the first lane (78L) located on one side of the host vehicle lane (78C) which is a lane in which the host vehicle (10) is traveling, whereas in the case that the operation input to the second operation input unit is detected by the operation detection unit, the lane change control unit performs the lane change into the second lane (78R) located on the other side of the host vehicle lane. In accordance with such a configuration, in the case that an operation input to the first operation input unit, which is positioned on the one side in the vehicle widthwise direction with respect to the center of the steering wheel, is performed, a lane change is made into the lane located on the one side of the host vehicle lane. Further, in the case that an operation input to the second operation input unit, which is positioned on the other side in the vehicle widthwise direction with respect to the center of the steering wheel, is performed, a lane change is made into the lane located on the other side of the host vehicle lane. Thus, in accordance with such a configuration, it is possible for the vehicle control device having suitable operability to be provided.

The first operation input unit may comprise the first operation switch which is positioned on the one side in the vehicle widthwise direction with respect to the center of the steering wheel and is provided on the rear side of the steering wheel, and the second operation input unit may comprise the second operation switch which is positioned on the other side in the vehicle widthwise direction with respect to the center of the steering wheel and is provided on the rear side of the steering wheel. In accordance with such a configuration, since the lane change can be instructed using the first operation switch or the second operation switch provided on the rear side of the steering wheel, it is possible for the vehicle control device having suitable operability to be provided.

The first operation input unit may comprise the first contact sensor positioned on the one side in the vehicle widthwise direction on the steering wheel, when the steering wheel is in a neutral position, and the second operation input unit may comprise the second contact sensor positioned on the other side in the vehicle widthwise direction on the steering wheel, when the steering wheel is in the neutral position. In accordance with such a configuration, by contacting the one side of the steering wheel, it is possible to instruct a lane change into the lane located on the one side of the host vehicle lane. Further, by contacting the other side of the steering wheel, it is possible to instruct a lane change into the lane located on the other side of the host vehicle lane. Thus, in accordance with such a configuration, it is possible for the vehicle control device having suitable operability to be provided.

The operation input may be an operation input that causes a contact location with the steering wheel to move in a predetermined direction. In accordance with such a configuration, since the lane change is not performed unless the contact location with the steering wheel is moved in the predetermined direction, a mistaken operation can be prevented.

The vehicle control device may further comprise the first mode in which the operation input is detected as a request to perform the lane change by the user, and the second mode in which the operation input is detected as a consent from the user to a proposal to perform the lane change, the operation detection unit may detect the operation input on the basis of an amount of operation, which is performed by the user to the operation input unit, having reached the operation amount threshold value, and the operation amount threshold value in the second mode may be less than the operation amount threshold value in the first mode. In accordance with such a configuration, since the operation amount threshold value in the first mode is set to be comparatively large, it is possible to contribute to an improvement in safety when operating in the first mode. Further, in accordance with such a configuration, since the operation amount threshold value in the second mode is set to be comparatively small, it is possible to contribute to an improvement in operability when operating in the second mode.

The above-described vehicle control device may further include the first driving control state in which the user is required to be grasping the steering wheel, and the second driving control state in which the user is not required to be grasping the steering wheel, the operation input unit may further include the third operation input unit (68C) and the fourth operation input unit (68D), the third operation input unit may comprise the first contact sensor positioned on the one side in the vehicle widthwise direction with respect to the center of the steering wheel, when the steering wheel is in the neutral position, the fourth operation input unit may comprise the second contact sensor positioned on the other side in the vehicle widthwise direction with respect to the center of the steering wheel, when the steering wheel is in the neutral position, and in the first driving control state, the lane change control unit may perform the lane change on the basis of the operation input to the first operation input unit or the second operation input unit, whereas in the second driving control state, the lane change control unit may perform the lane change on the basis of the operation input to the third operation input unit or the fourth operation input unit. In accordance with such a configuration, in the first driving control state in which the user is required to be grasping the steering wheel, the lane change can be performed on the basis of the operation input to the first operation input unit or the second operation input unit. On the other hand, in the second driving control state in which the user is not required to be grasping the steering wheel, the lane change can be performed on the basis of the operation input to the third operation input unit or the fourth operation input unit. Thus, in accordance with such a configuration, it is possible for the vehicle control device having suitable operability to be provided.

The vehicle (10) comprises the vehicle control device as described above.

The vehicle control method comprises the step (step S1, step S2) of detecting an operation input performed by a user to the operation input unit provided on the steering unit including the steering wheel, and the step (step S3, step S4) of controlling a lane change on the basis of the operation input detected in the step of detecting the operation input, wherein the operation input unit includes the first operation input unit positioned on one side in a vehicle widthwise direction with respect to the center of the steering wheel, and the second operation input unit positioned on another side in the vehicle widthwise direction with respect to the center of the steering wheel, and in the step of controlling the lane change, in the case that the operation input to the first operation input unit is detected (step S1), the lane change is performed into the first lane located on one side of the host vehicle lane which is the lane in which the host vehicle is traveling (step S3), whereas in the case that the operation input to the second operation input unit is detected (step S2), the lane change is performed into the second lane located on the other side of the host vehicle lane (step S4).

What is claimed is:

1. A vehicle control device, comprising:
an operation detection unit configured to detect an operation input performed by a user to an operation input unit provided on a steering unit including a steering wheel; and
a lane change control unit configured to control a lane change on a basis of the operation input detected by the operation detection unit,
wherein the operation input unit includes a first operation input unit positioned on one side in a vehicle widthwise direction with respect to a center of the steering wheel, and a second operation input unit positioned on another side in the vehicle widthwise direction with respect to the center of the steering wheel, and
in a case that the operation input to the first operation input unit is detected by the operation detection unit, the lane change control unit performs the lane change into a first lane located on one side of a host vehicle lane which is a lane in which a host vehicle is traveling, whereas in a case that the operation input to the second operation input unit is detected by the operation detection unit, the lane change control unit performs the lane change into a second lane located on another side of the host vehicle lane.

2. The vehicle control device according to claim 1, wherein:
the first operation input unit comprises a first operation switch positioned on the one side in the vehicle widthwise direction with respect to the center of the steering wheel, and provided on a rear side of the steering wheel; and
the second operation input unit comprises a second operation switch positioned on the other side in the vehicle widthwise direction with respect to the center of the steering wheel, and provided on the rear side of the steering wheel.

3. The vehicle control device according to claim 1, wherein:
the first operation input unit comprises a first contact sensor positioned on the one side in the vehicle widthwise direction on the steering wheel, when the steering wheel is in a neutral position; and
the second operation input unit comprises a second contact sensor positioned on the other side in the vehicle widthwise direction on the steering wheel, when the steering wheel is in the neutral position.

4. The vehicle control device according to claim 3, wherein the operation input is an operation input that causes a contact location with the steering wheel to move in a predetermined direction.

5. The vehicle control device according to claim 1, further comprising:
a first mode in which the operation input is detected as a request to perform the lane change by the user; and
a second mode in which the operation input is detected as a consent from the user to a proposal to perform the lane change, wherein:
the operation detection unit detects the operation input on a basis of an amount of operation, which is performed by the user to the operation input unit, having reached an operation amount threshold value; and
the operation amount threshold value in the second mode is less than the operation amount threshold value in the first mode.

6. The vehicle control device according to claim 2, further comprising a first driving control state in which the user is required to be grasping the steering wheel, and a second driving control state in which the user is not required to be grasping the steering wheel, wherein:
the operation input unit further includes a third operation input unit, and a fourth operation input unit;
the third operation input unit comprises a first contact sensor positioned on the one side in the vehicle widthwise direction with respect to the center of the steering wheel, when the steering wheel is in a neutral position;
the fourth operation input unit comprises a second contact sensor positioned on the other side in the vehicle widthwise direction with respect to the center of the steering wheel, when the steering wheel is in the neutral position; and
in the first driving control state, the lane change control unit performs the lane change on a basis of the operation input to the first operation input unit or the second operation input unit, whereas in the second driving control state, the lane change control unit performs the lane change on a basis of the operation input to the third operation input unit or the fourth operation input unit.

7. A vehicle comprising a vehicle control device,
the vehicle control device comprising:
an operation detection unit configured to detect an operation input performed by a user to an operation input unit provided on a steering unit including a steering wheel; and
a lane change control unit configured to control a lane change on a basis of the operation input detected by the operation detection unit,
wherein the operation input unit includes a first operation input unit positioned on one side in a vehicle widthwise direction with respect to a center of the steering wheel, and a second operation input unit positioned on another side in the vehicle widthwise direction with respect to the center of the steering wheel, and
in a case that the operation input to the first operation input unit is detected by the operation detection unit, the lane change control unit performs the lane change into a first lane located on one side of a host vehicle lane which is a lane in which a host vehicle is traveling, whereas in a case that the operation input to the second operation input unit is detected by the operation detection unit, the lane change control unit performs the lane change into a second lane located on another side of the host vehicle lane.

8. A vehicle control method, comprising:
a step of detecting an operation input performed by a user to an operation input unit provided on a steering unit including a steering wheel; and
a step of controlling a lane change on a basis of the operation input detected in the step of detecting the operation input,
wherein the operation input unit includes a first operation input unit positioned on one side in a vehicle widthwise direction with respect to a center of the steering wheel, and a second operation input unit positioned on another side in the vehicle widthwise direction with respect to the center of the steering wheel, and
in the step of controlling the lane change, in a case that the operation input to the first operation input unit is detected, the lane change is performed into a first lane located on one side of a host vehicle lane which is a lane in which a host vehicle is traveling, whereas in a case that the operation input to the second operation input unit is detected, the lane change is performed into a second lane located on another side of the host vehicle lane.
